(19) United States
(12) Patent Application Publication
(10) Pub. No.: US 2021/0122285 A1
(43) Pub. Date: Apr. 29, 2021

(54) TRUCK MATTRESS AND COVER

(71) Applicant: Kenneth Dean Brown, Phoenix, AZ (US)

(72) Inventor: Kenneth Dean Brown, Phoenix, AZ (US)

(21) Appl. No.: 17/082,575

(22) Filed: Oct. 28, 2020

Related U.S. Application Data
(60) Provisional application No. 62/927,258, filed on Oct. 29, 2019.

(51) Int. Cl. B60P 3/38; E04H 15/06

(52) U.S. Cl. CPC B60P 3/38; E04H 15/06

(57) ABSTRACT

A covered mattress assembly for a vehicle bed is provided. The covered mattress assembly includes at least one mattress having multiple joints and a cover assembly. The mattress is concealed within a vehicle bed by the cover assembly. In some cases, the cover assembly is inverted for use from the storage position. The cover assembly includes a spring-loaded arm operative to lift the cover assembly.

### CROSS-REFERENCE TO RELATED APPLICATION

This application claims the benefit of priority of U.S. provisional application No. 62/927,258, filed Oct. 29, 2019, the contents of which are herein incorporated by reference.

### BACKGROUND OF THE INVENTION

The present invention relates to portable beds for use in a truck and, more particularly, to a hard cover with canvas sides for an internal folding mattress mounted on truck-bed sides.

Travelers, including hunters, often find a lack of cheap sleeping accommodations without an RV or hotel. While a truck owner may wish to sleep in the truck, currently available truck covers generally do not have a bed or mattress. Existing mattresses for use with a truck are not easily contained inside the truck bed and are bulky, causing a higher center of gravity. Truck owners/drivers often must tow a camper trailer or setup a tent on the ground to sleep. This is both inconvenient and consumes time for the driver.

Other currently available products include more than a sleeping place and are thus expensive.

As can be seen, there is a need for an improved and convenient truck mattress that allows the owner to unfold a sleeping bed(s) that fits under the truck lid, cover, or shell, to provide temporary shelter when desired.

The present invention provides a camp bed adapted to fold into the truck and then unfold to variously configure the bed(s) under the lifted cover and/or on the sides of the vehicle like saddlebags on the truck bed exterior sides. Thus, it easily converts the pickup bed into a sleeping space, providing a dry bed to sleep in when raining, snowing, etc., with minimal effort and no nightly expense. The truck owner no longer must tow a camper trailer or setup a tent on the ground to provide a safe sleeping accommodation. The invention may be used for recreational vehicles (RVs), trailers, vans, boats, and beds hanging from the walls of a homeless shelter.

### SUMMARY OF THE INVENTION

In one aspect of the present invention, a covered mattress assembly for a vehicle bed is provided, comprising at least one mattress having a plurality of joints and a cover assembly.

In another aspect of the present invention, a covered mattress assembly for a vehicle bed, comprising a mattress attached to a cover assembly; wherein the mattress in a storage position is concealed within a vehicle bed by the cover assembly; and wherein a use position is an inverse of the storage position.

In another aspect of the present invention, a covered mattress assembly for a vehicle bed, comprising at least one mattress and a cover assembly comprising a spring-loaded arm operative to lift the cover assembly.

These and other features, aspects and advantages of the present invention will become better understood with reference to the following drawings, description, and claims.

### BRIEF DESCRIPTION OF THE DRAWINGS

FIG. 1 is a rear-top perspective view of a mattress cover according to an embodiment of the invention, shown in a closed position;

FIG. 2 is a rear view thereof, shown in an open position;

FIG. 3 is a top plan view thereof;

FIG. 4 is a front-top perspective view thereof;

FIG. 5 is a side view thereof, shown in a semi-open position;

FIG. 6 is a rear-top perspective view thereof, shown in an open position;

FIG. 7 is a rear elevation view thereof, shown in a closed position;

FIG. 8 is a rear elevation view of an extended mattress according to an embodiment of the invention, shown in an open position on a truck;

FIG. 9 is a rear elevation view thereof, shown in a closed position;

FIG. 10 is a rear elevation view of an extended mattress cover with solar panels, illustrating unfolding the mattress into an open position;

FIG. 11 is a perspective view of an extended mattress cover according to an embodiment of the present invention, shown with the bed in an elevated position and the mattress in a closed position;

FIG. 12 is a perspective view thereof, shown with the bed in a lowered position and illustrating folding the mattress into an open position;

FIG. 13 is a schematic view of a bed extension according to an embodiment of the present invention, shown with a truck cap, with a full-size shell, and without a cover;

FIG. 14 is a perspective view of a tailgate extension according to an embodiment of the present invention, shown in extended position;

FIG. 15 is a schematic view of a tailgate extension according to an embodiment of the present invention;

FIG. 16 is a perspective view of a tailgate extension with a tailgate mattress according to an embodiment of the present invention, shown in an open position;

FIG. 17 is a rear elevation view thereof, shown in a closed position;

FIG. 18 is a side schematic view of a tailgate mattress and a truck bed mattress, shown in hidden, closed position;

FIG. 19 is a schematic view, illustrating opening of a folding extendable mattress according to an embodiment of the present invention and illustrating opening of a sliding extendable mattress in another embodiment of the present invention;

FIG. 20 is a schematic view, illustrating opening of a folding tailgate mattress;

FIG. 21 is a rear view thereof;

FIG. 22 is a schematic view of an embodiment of the present invention, illustrating opening of a slidable tailgate mattress extension;

FIGS. 23-25 are schematic views of bed side extensions and connectors according to embodiments of the present invention;

FIGS. 26-27 are schematic views of a rigid tonneau cover with an attached mattress according to an embodiment of the present invention, shown in a stored position and a use position, respectively;

FIG. 28 is a schematic top perspective view thereof;

FIG. 29 is a schematic bottom perspective view thereof;

FIG. 30 is a schematic view of an extendable tonneau cover with an attached mattress, according to an embodiment of the present invention;

FIG. 31 is a schematic perspective view thereof, shown in use position;

FIG. 32 is a schematic perspective view of an extendable tonneau cover with a mattress and side supports, according to an embodiment of the present invention;

FIG. 33 is a schematic view of a portable folding mattress according to an embodiment of the present invention, shown in a stored position;

FIG. 34 is a schematic view thereof, shown in a partly opened position;

FIGS. 35-36 are schematic views thereof, showing deployment into a use position;

FIGS. 37-38 are schematic views of a portable folding mattress with a center reinforcement according to an embodiment of the present invention, shown in stored position and in use position, respectively;

FIGS. 39-41 are schematic views of an extendable cover according to an embodiment of the present invention, shown in lowered, intermediate, and raised positions, respectively;

FIGS. 42-44 are schematic views of a tonneau cover with a mattress and a canvas cover according to an embodiment of the present invention, shown in stored (FIGS. 42 and 43) and in use positions (FIG. 44);

FIG. 45-47 are schematic views of an adjustable length canvas cover according to an embodiment of the present invention, shown in expanded and collapsed positions;

FIG. 48-49 are schematic views of a murphy style folding mattress according to an embodiment of the present invention, shown in storage position and in use position, respectively;

FIGS. 50-51 are schematic views of a flush-to-bed murphy style folding mattress according to an embodiment of the present invention, shown in storage position and in use position, respectively;

FIGS. 52-53 are schematic views of a tailgate-installed air mattress with cover according to an embodiment of the present invention, shown in storage position and in use position, respectively;

FIG. 54 is a schematic view of a shell with saddle bags according to an embodiment of the present invention;

FIG. 55 is a schematic view thereof, shown with a kitchenette accessory on the tailgate;

FIGS. 56-57 are schematic views of a telescoping rigid shell according to an embodiment of the present invention, shown in expanded and collapsed positions, respectively;

FIGS. 58-60 are schematic views of a telescoping A-frame shell according to an embodiment of the present invention, shown in expended and collapsed positions.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “truck bed” refers to standard, short, or long size truck beds. The term “vehicle bed” as used herein refers to a truck bed and to counterpart elements of a RV, trailer, van, and boat.

The terms “bed” and “mattress” are used interchangeably herein. Similarly, the terms “shell”, “cover”, and “lid” are used interchangeably herein. The terms must be interpreted in the context of the surrounding paragraph.

Broadly, one embodiment of the present invention is an assembly including a sleeping mattress and a cover on one or both sides of a pickup shell, cover, or lid. The mattress may fold out for use inside or outside of the truck bed when the truck cover or lid is elevated or telescopically collapsed, the bed is lowered or slid out of the truck bed, and/or the mattress cover is reversed (i.e., flipped over to an inverse position).

The inventive covered mattress assembly provides a safe sleeping space under a truck bed cover while allowing the shell, cover, and/or lid to conceal a folding sleeping bed. The sleeping bed may have jointed components that fold at joints.

Beneficially, the truck lid cover/or shell covers and protects the underlying components from the rain and elements. Once elevated, the lid/shell is out of the way and exposes the bed which if not already in place, may be extended to its exterior place by unfolding its panels and locking them in place by cables or supports built into the bed components.

In one embodiment, the present invention comprises a truck bed lid or cover, a lifting mechanism for the truck cover/lid, a sleeping bed, either fixed or folding, and canvas or plastic folding sides between a tuck cover or lid connecting to the sleeping beds, including a mattress.

In some embodiments, the mattress may “pop up” for use with a tonneau.

In an embodiment, the mattress further comprises a mattress tray and headboard.

In some embodiments, the invention may comprise tent sides and beds, generally stored inside an existing truck bed under a truck bed cover or lid.

A shell cover or lid may be opened by a lifting mechanism/levers/dampers/springs underneath the cover/lid. Inside the truck bed, a sleeping bed may already be extended to its open position or it may be retracted into the truck bed area by folding hinged panels with cushions for sleeping. The folded panels may be unfolded and placed on each side of the pickup truck bed to resemble wings with one bed on each side of the truck bed exterior. The folded panels may be unfolded from the exterior or interior. The flexible canvas/plastic sides may be connected between the truck cover/lid and the outside of the bed wings to enclose the occupants to protect against bugs, wild animals, and/or rain. The tent sides may be easily retracted, the bed may be folded, moving it inside the truck bed, and the truck lid/cover may be lowered.

The wings of the beds may be configured in various patterns, permitting either one or both beds to be mounted exterior on the truck bed sides. In one embodiment, the bed may already be extended under the cover. The bed may be lifted together with the cover if the owner wishes to access the volume under the bed for storage, or the cover may be lifted without the bed thus allowing the bed to be slept on.

If desired, the canvas sides may be unfolded, thus providing more shelter and security against the elements, insects, and/or predators. The devices fit neatly into the truck bed interior and the lid/covers may be lowered for traveling, thus providing a lighter and more aerodynamic truck profile.

Spring-assisted dampened guided locking arms may be provided to raise and lower the cover, the mattress, or both. The cover corners may be locked into position as the locking arms are extended from their horizontal position to their vertical support positions. Springs and gravity assist in overcoming the weight of the lid/cover during its movement.

In one example, when traveling, the user may simply pull over in a rest area and lift the lid or cover to unfold the bed by simply pulling a strap to activate spring-loaded hinges, allowing the sleeping bed to unfold. The user may connect the canvas/plastic covers to the lid, to the bed, and/or to the tailgate when extended.

Camping shells may be manufactured with sleeping shell mattresses on shell sides. In some embodiments, the camping shell may further comprise an outdoor shower and/or solar powered roof panels.

In one embodiment, the present invention provides a complete unit including lid or shell cover, bed, and canvas sides. The complete unit may be easily installed by a dealer or handy person. Preferably, the shell or lid comes assembled. The retractable beds may be installed separately, for example, below the shell or cover lid. The cushioning may be pre-attached to the panels and may be replaced when worn out or damaged.

In one embodiment, the truck lid may be deepened to accommodate the desired depth of the sleeping beds underneath it. The supports for the lid may be built into the lid and unfolded.

In one embodiment, the protective sides of the truck bed cover may repel insects, rain, etc.

Generally, the present invention may accommodate from about 1 to about 4 people.

In some embodiments, a drop-down tailgate mechanism may be used to automatically control the opening and closing of the mattress(es), awning, and/or shell components. Lighting, solar power, and shower may all be digitally controlled by a panel.

In some embodiments, the present invention may comprise electrical connections for universal serial bus (USB) and light emitting diode (LED) lighting/light fixture(s).

In some embodiments, a kitchen may be provided on the truck tailgate. The kitchen may comprise appliances including, but not limited to, a sink and a stove.

In some embodiments, hanging truck bed saddlebag storage units may be provided.

The materials of construction are not particularly limited and may include, but are not limited to, metals, fiberglass, plastic, and combinations thereof. Tent sides may be made from canvas, plastic, and a combination thereof. The components may be manufactured using known manufacturing techniques.

The present invention may, in some embodiments, be used in a boat, providing a bed that extends over the side(s) of the boat.

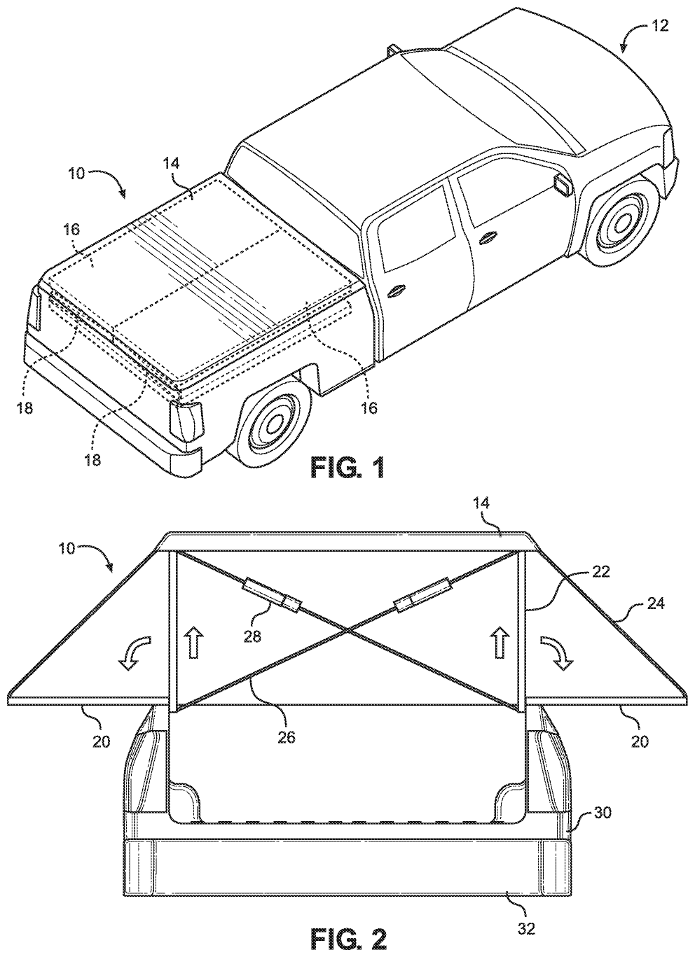

Referring to FIGS. 1-60, FIG. 1 show a mattress cover 10 on a truck 12 comprising a truck bed cover 14 and two tent sides 16. Two lift arms 18 are shown, configured to raise the truck bed cover 14 and/or the two tent sides. FIG. 2 illustrates deployment of the mattress cover 10 to a use position, raising upright supports 22 and lowering side panels 20. The mattress cover 10 is held in position over the truck bed 30 with support cables 24, 26, each of which has a tensioner 28.

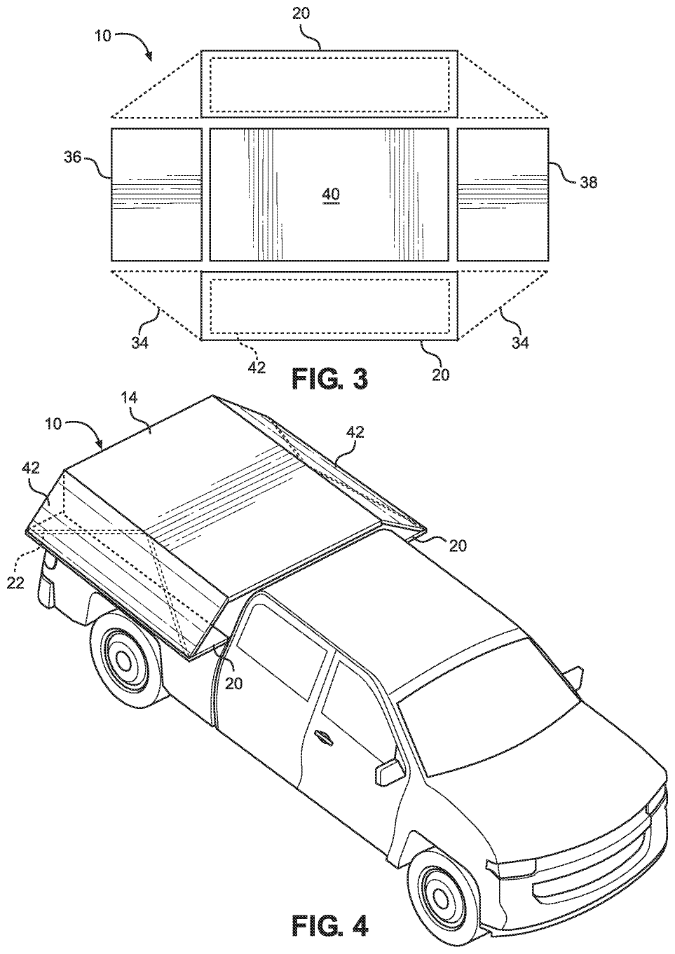

FIG. 3 shows an embodiment in which the top 40 of the mattress cover 10 additionally has a front 38 and a back awning 36. In some embodiments, each side panel 20 may also have retractable awnings 42 and corner awnings 34. FIG. 4 shows the retractable awnings 42 extended for use.

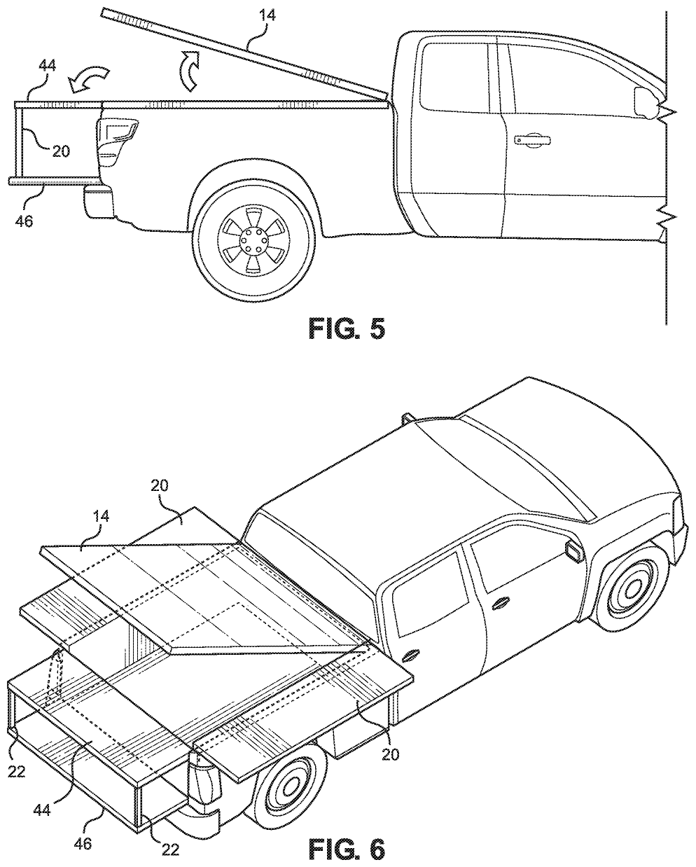

FIGS. 5 and 6 illustrate an embodiment further having a back panel 44 which may be folded out when the truck bed cover 14 is raised. The back panel 44 may be supported by way of upright supports 22 on the truck tailgate 46.

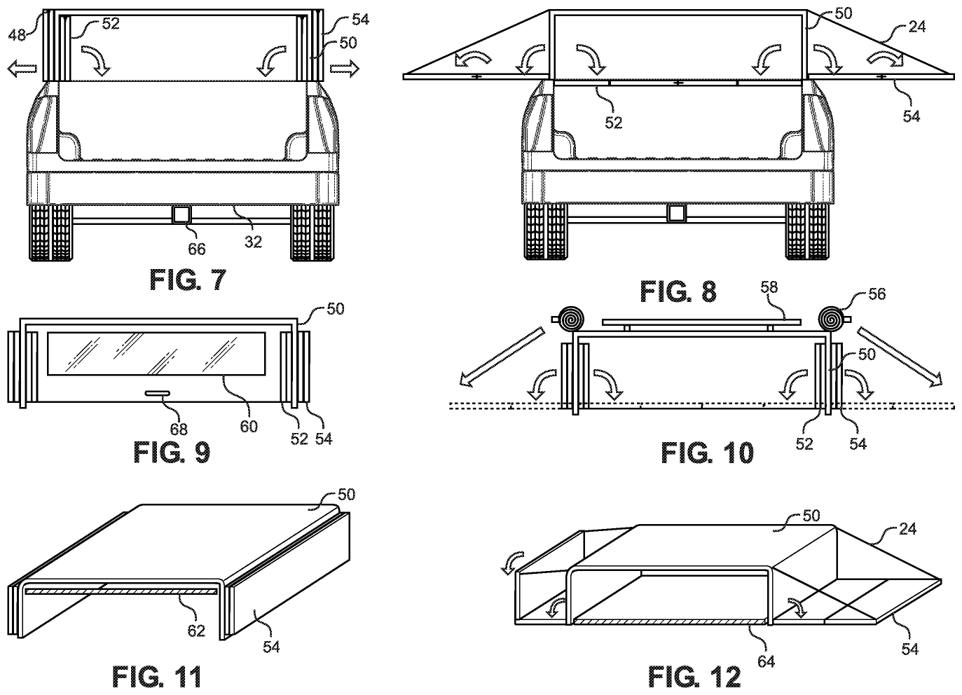

FIGS. 7 and 8 illustrate a stored position and a use position, respectively, of an extended mattress cover 50 having both an inner extendable mattress 52 and a pair of outer extendable mattresses 54. As shown, the extendable mattresses 52, 54 may each fold at a piano hinge 48, although the invention is not limited to a particular type of hinge. When folded out, the outer extendable mattress 54 may be stabilized with a support cable 24. Note that the hitch 66 remains accessible. As shown in FIG. 9, the extended mattress cover 50 is enclosed with a door having a glass window 60 and a handle 68. FIG. 10 illustrates a fixed solar panel 58 deployed on top of the extended mattress cover 50 and furled extendable solar panels which may be unfurled to cover the opened outer extendable mattresses.

FIGS. 11 and 12 illustrate an alternative embodiment wherein the inner extendible mattress 52 is replaced with a bed shown in a raised position 62 for storage and a lowered position 64 for use.

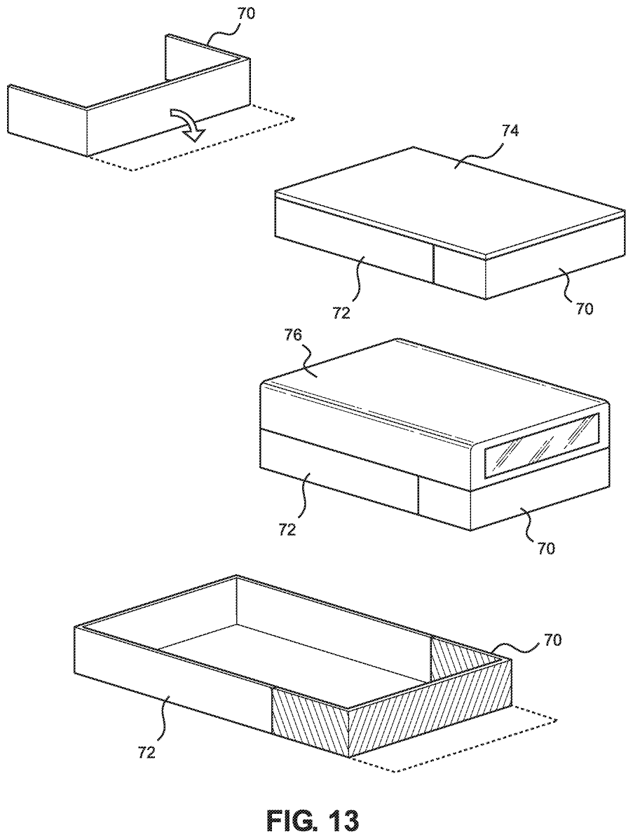

FIG. 13 shows a bed extension component 70 to a truck bed 72 for use with a long bed truck cap 74 or a full-size shell 76. The bed extension 70 may extend the length of the mattress used therewith.

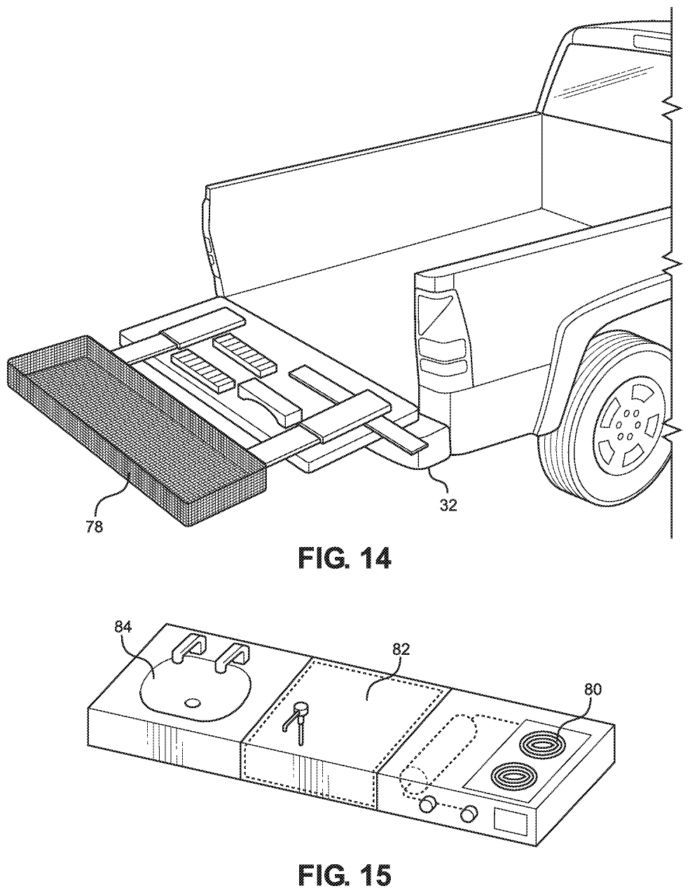

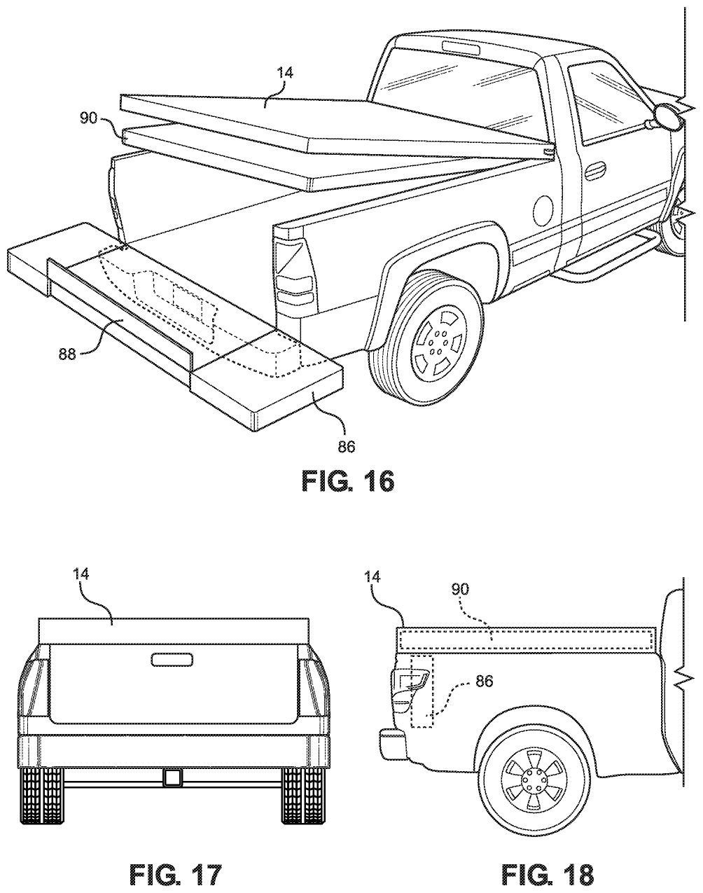

As shown in FIGS. 14-18, an embodiment of the invention further includes accessory components on the truck tailgate 46 over the truck bumper 32. FIG. 14 illustrates a mesh carrier 78 extended from the rear of the truck bed 30. FIG. 15 illustrates a kitchenette combination of a stovetop 80, a water reservoir 82, and a sink 84. FIG. 16 shows a tailgate mattress 86 with a foldable security catch 88, supplementing a mattress 90 under the truck bed cover 14. FIGS. 17-18 show the truck bed cover 14 covering the mattress 90 and the tailgate mattress 86 in a stored position.

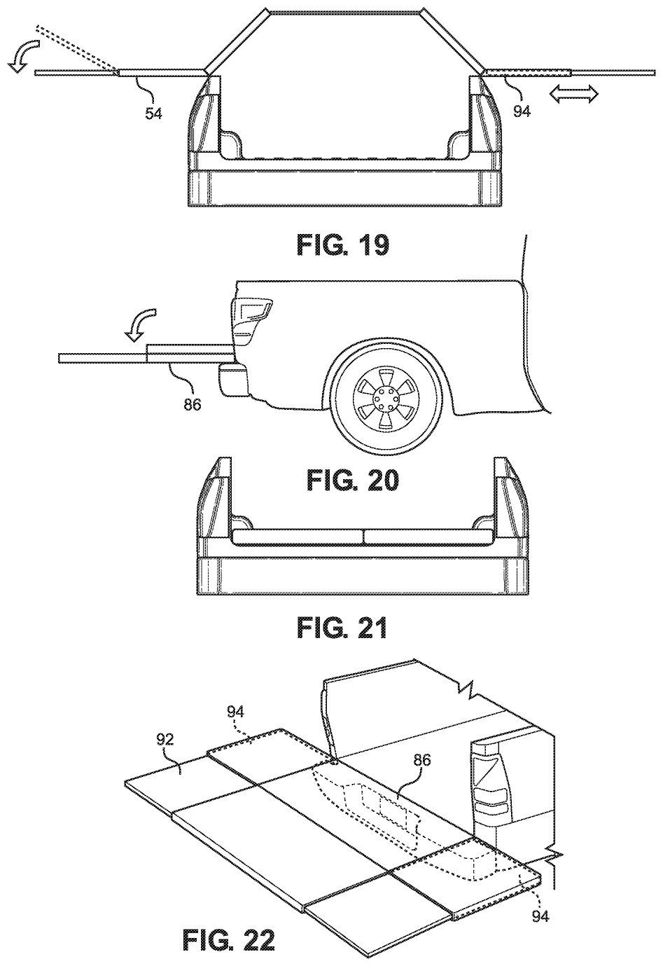

FIGS. 19-22 illustrate extendibility features of various mattress embodiments. FIG. 19 shows both a foldout outer extendable mattress 54 and an outer extendable mattress 54 with a slidable component stored within an internal cavity 94. FIGS. 20-21 show a foldout portion of a tailgate mattress 86. FIG. 22 shows a tailgate mattress 86 with internal cavities 94 from which pull-out extensions 92 are stored.

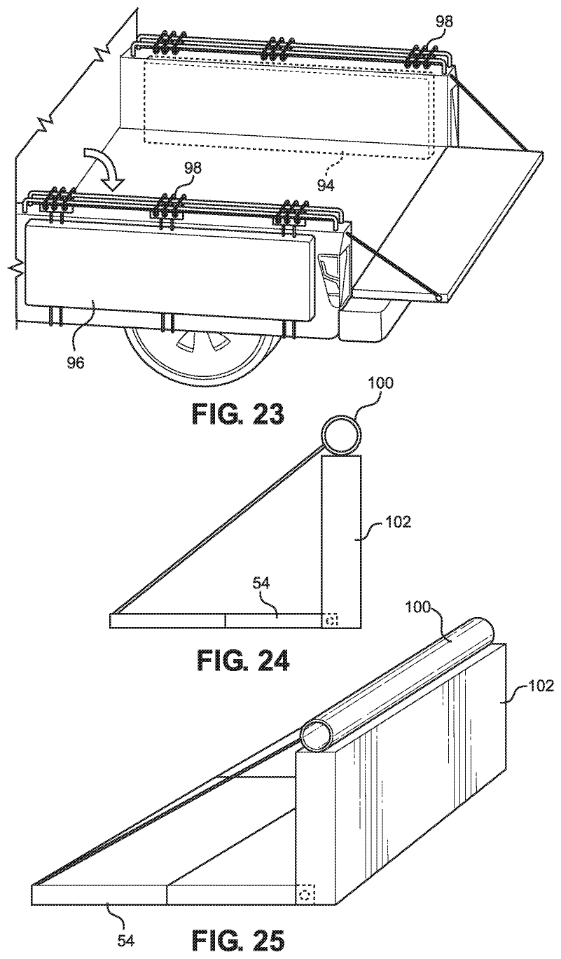

FIGS. 23-25 show an embodiment in which an outer extendable mattress 54 is stored within the internal cavity 94 of a saddle bag 96 attached on each side of the truck 12 using cable supports 98. The extended mattress 54 is supported by cables stored in a canister 100 positioned atop the container 102 portion of the saddle bag 96.

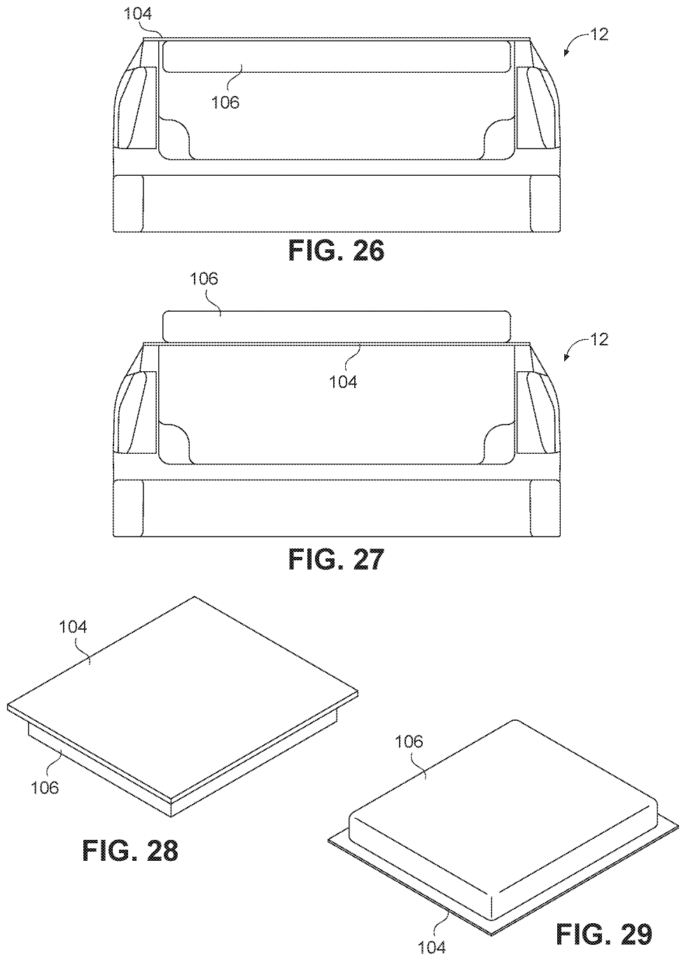

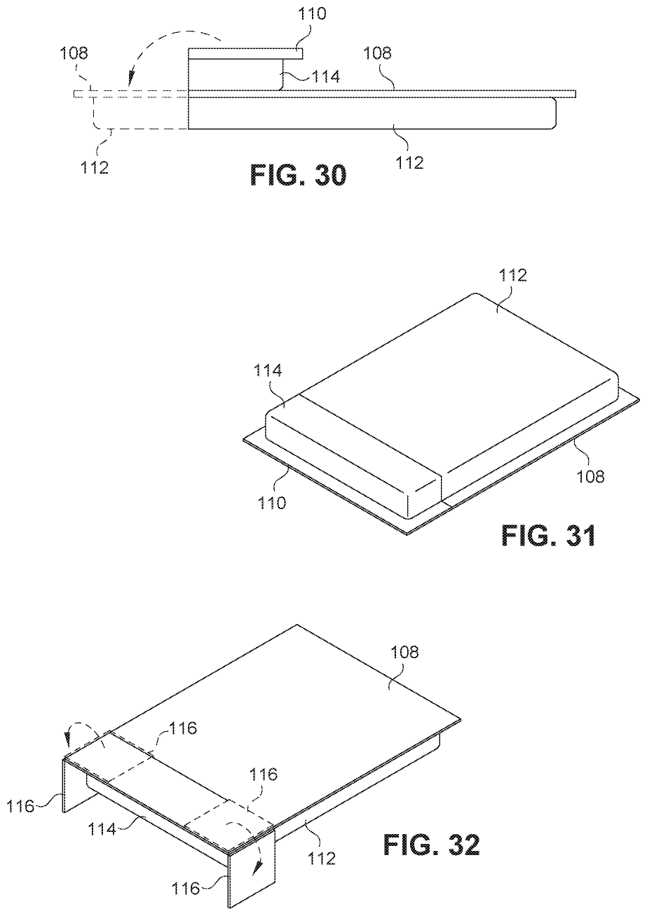

FIGS. 26-29 show an embodiment including a rigid tonneau cover 104 with an attached mattress 106 on a truck 12. FIGS. 30-31 show an extendable rigid tonneau cover 108 with an extension 110 and an attached mattress 112 with a mattress extension 114. FIG. 32 illustrates the extended cover and mattress of FIGS. 30-31 also having side supports 116.

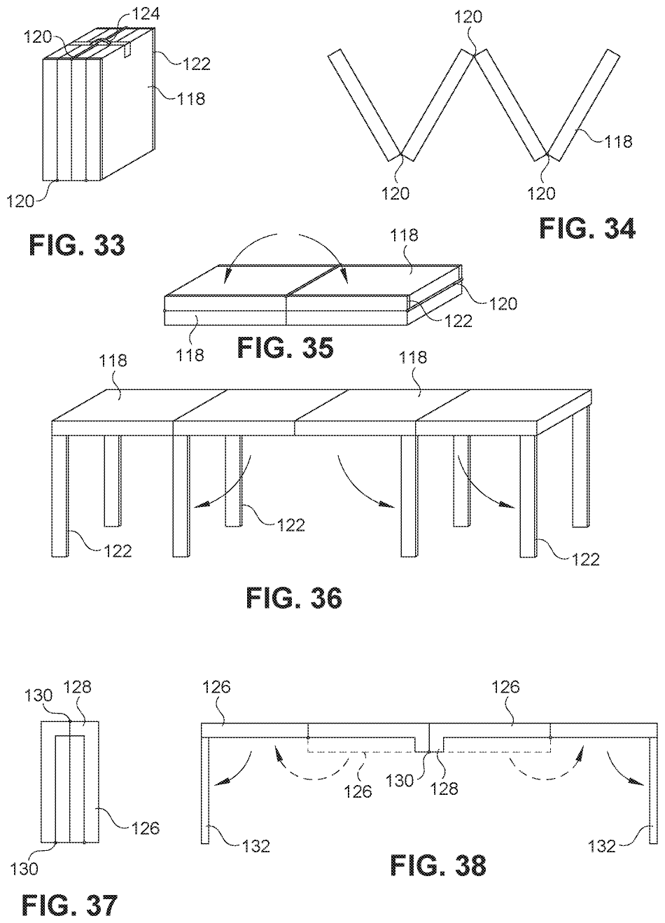

The present invention includes folding mattresses for storage within the truck bed 30. FIGS. 33-36 show a fold-up mattress 118 with hinge points 120, support legs 122, and a handle 124. FIGS. 37-38 show an alternate embodiment of a folding mattress 126 having center reinforcements 128 at the central hinge point 130. The mattress 126 is also shown with fold-out supports 132.

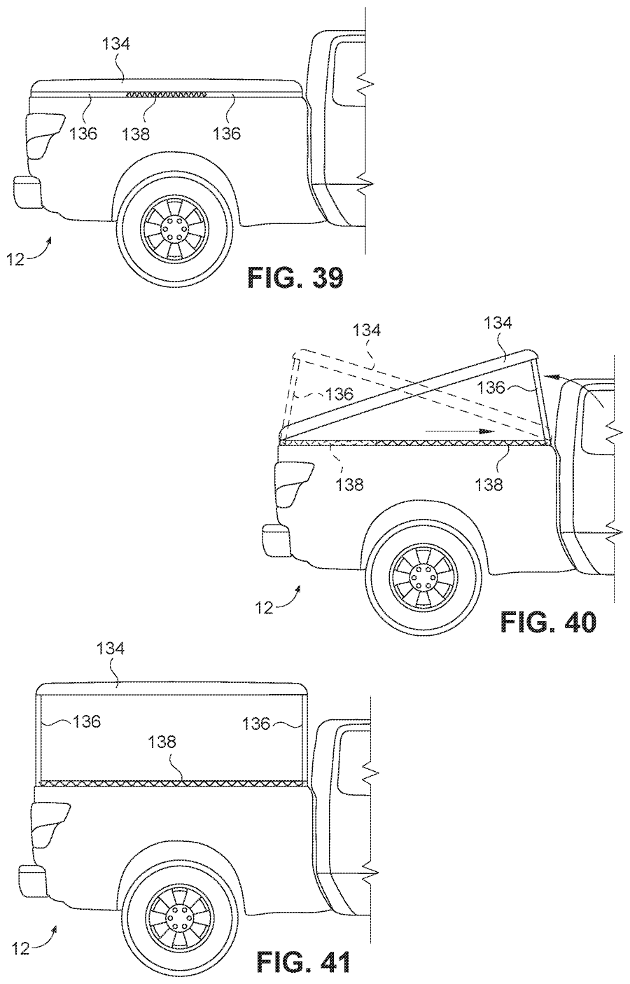

In some embodiments illustrated in FIGS. 39-41, the invention includes an extendable cover 134 that may be raised from the truck bed by way of support arms 136 having a spring 138 to aid in raising and stabilizing the cover 134.

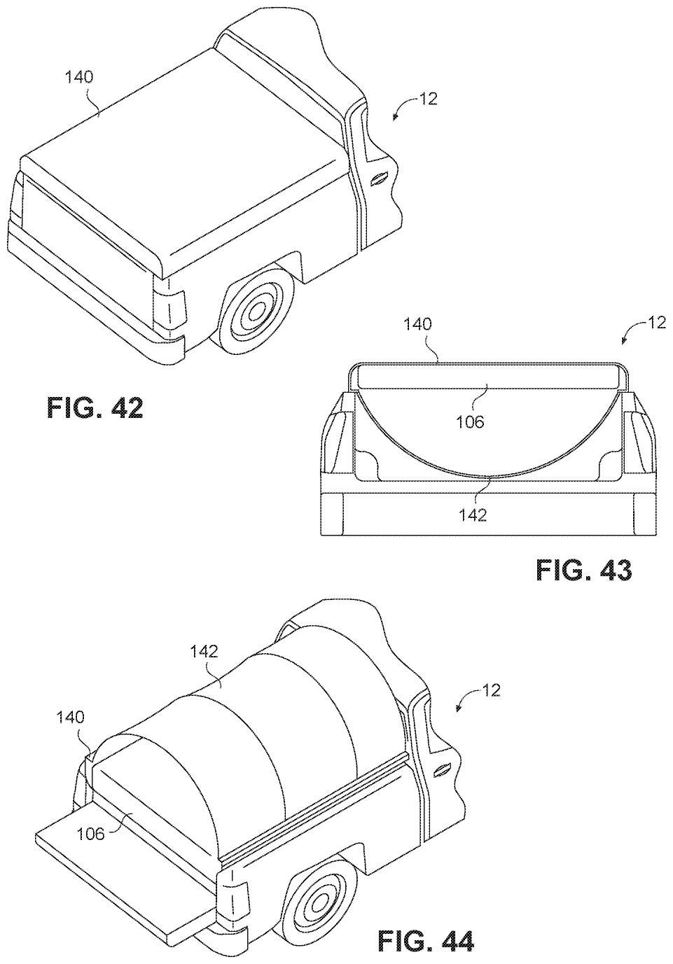

FIGS. 42-44 show an embodiment of the invention comprising a shell 140 with an attached mattress 106 and a canvas cover 142.

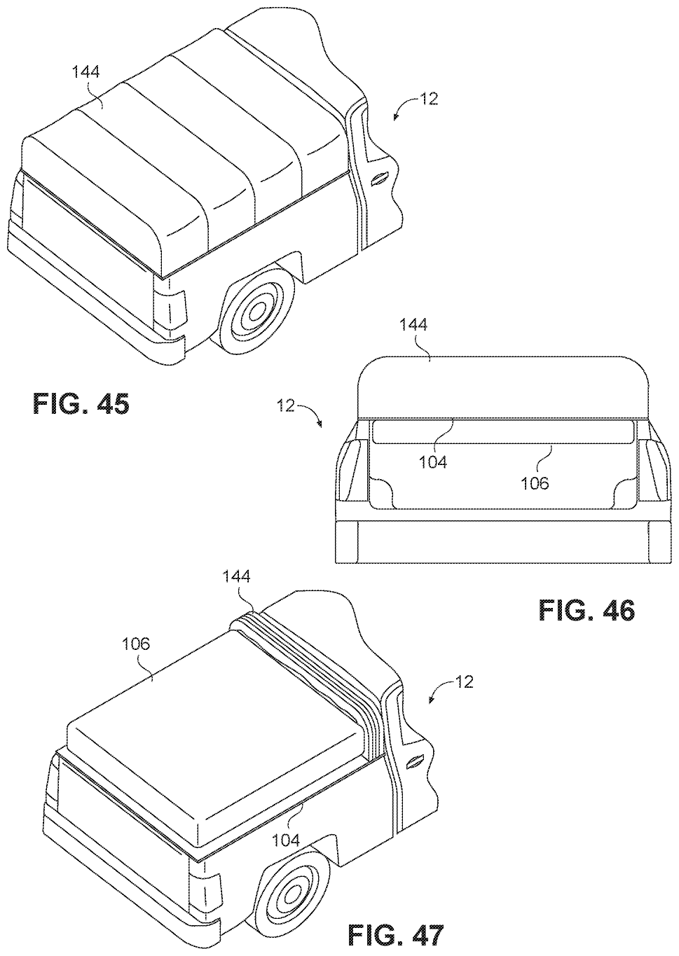

FIGS. 45-47 show an embodiment of the invention comprising an adjustable cover 144 to cover the mattress 106 attached the tonneau cover 104 of FIGS. 26-29. The cover 144 may comprise canvas, for example, and may fold or gather to allow open air use of the mattress 106.

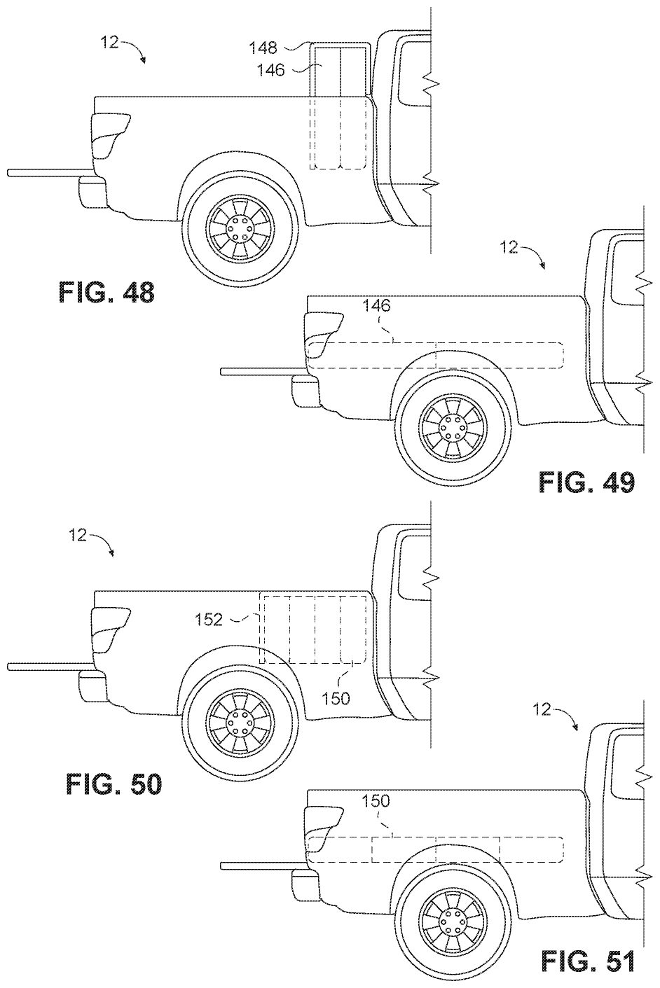

FIGS. 48-49 show an embodiment of the invention comprising a murphy style folding mattress 146 with a mattress cover 148 for use when the mattress 146 is in a stored position in the truck bed 30. FIGS. 50-51 show an alternative embodiment with a flush-bed folding mattress 150 and a mattress cover 152.

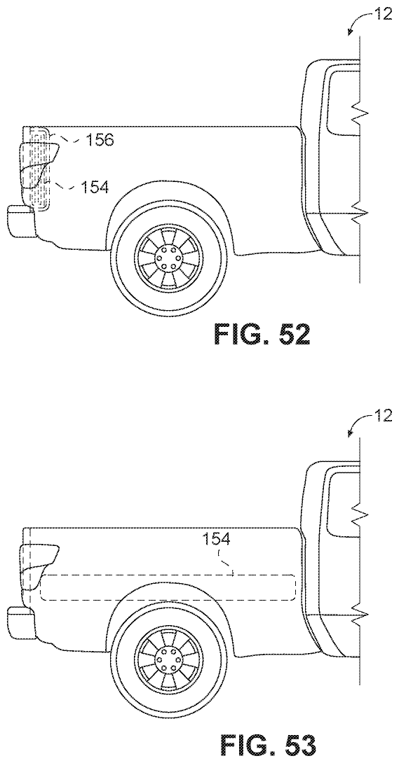

FIGS. 52-53 show an embodiment of the invention comprising an air mattress 154 secured within a tailgate mounted locking cover 156 when in a stored position. The mattress 154 may be inflated for use in the truck bed, as shown in FIG. 53.

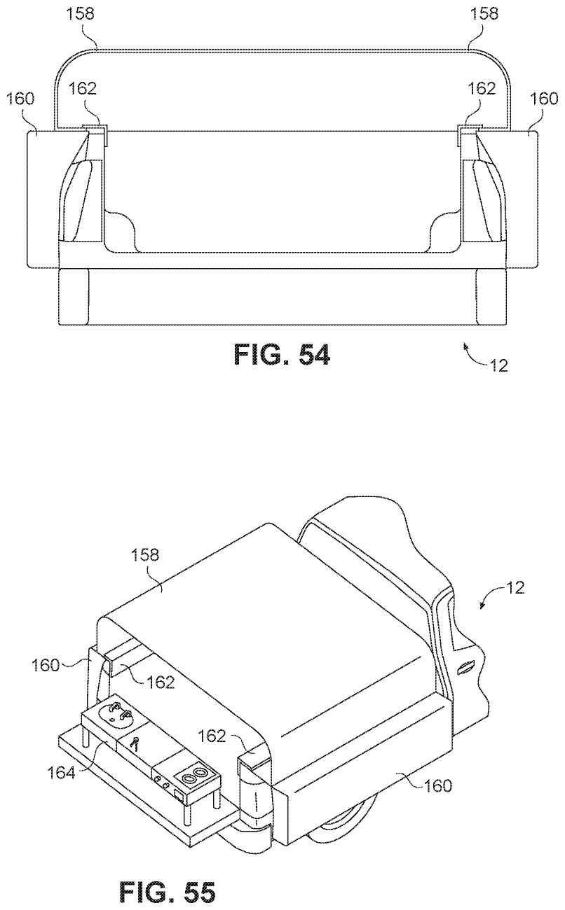

FIGS. 54-55 show an embodiment of the invention comprising a broad shell 158 positioned on a truck 12 in conjunction with saddle bags 160. The shell 158 comprises sliding adjustable mounting plates 162.

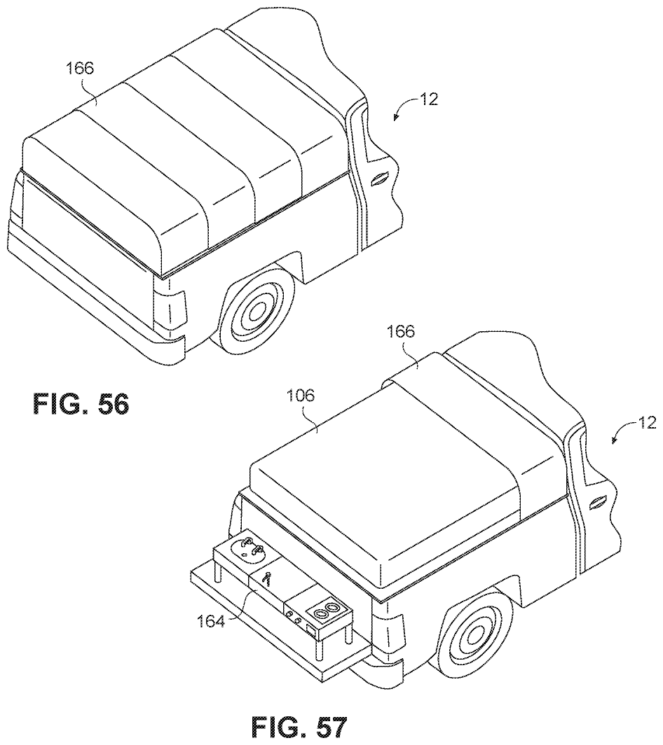

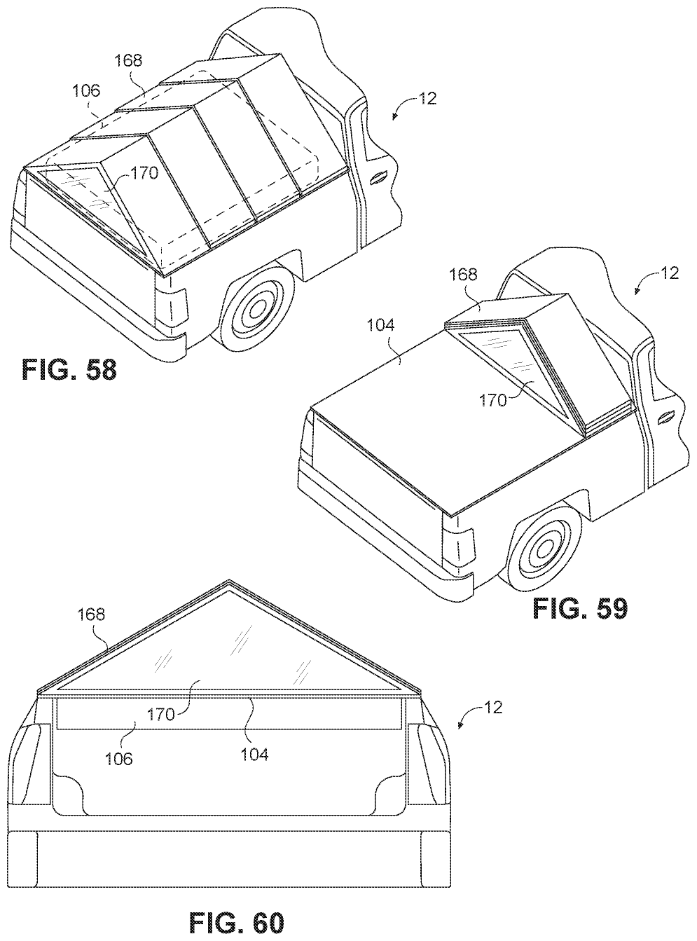

The present invention also provides a telescoping shell in some embodiments. FIGS. 56-57 show a telescoping hard shell 166, which may be retracted as shown in FIG. 57 to access the mattress 106 and protects the mattress 106 in its extended position, as shown in FIG. 56. FIGS. 58-60 show a telescoping A-frame shell 168 in conjunction with a tonneau cover 104 and attached mattress 106. The A-frame shell 168 may be extended to protect the user resting on the mattress 106, as shown in FIG. 58 and may be retracted when not in use, as shown in FIG. 59. As FIG. 60 illustrates, the A-frame shell may be provided with a window 170 for visibility.

FIGS. 55 and 57 also include an embodiment of the invention comprising a tailgate kitchen with fold-out legs 164.

It should be understood, of course, that the foregoing relates to exemplary embodiments of the invention and that modifications may be made without departing from the spirit and scope of the invention as set forth in the following claims.

What is claimed is:

1. A covered mattress assembly for a vehicle bed having sidewalls, comprising:
a. a cover assembly; and
b. at least one mattress hingedly attached thereto,
wherein the at least one mattress and the cover are configured to rest on the vehicle bed sidewalls, and wherein the at least one mattress is concealed by the cover assembly in a storage position.

2. The covered mattress assembly of claim 1, wherein the cover assembly comprises a cover and a lifting mechanism operative to lift the cover.

3. The covered mattress assembly of claim 2, wherein when the at least one mattress is in a storage position, the lifting mechanism is operable to lift the at least one mattress with the cover.

4. The covered mattress assembly of claim 1, wherein the at least one mattress is folded when in the storage position.

5. The covered mattress assembly of claim 1, wherein the at least one mattress is configured when in a use position to unfold to at least one position selected from the group consisting of: an interior of the vehicle bed, an exterior of the vehicle bed, and both the interior and exterior of the vehicle bed.

6. The covered mattress assembly of claim 1, wherein the assembly further comprises a mattress having a raised position and a lowered position within the vehicle bed.

7. The covered mattress assembly of claim 1, further comprising an accessory selected from the group consisting of: a mattress tray, a headboard, at least one tent side or awning, an outdoor shower, a solar powered roof panel, a universal serial bus connection, a light fixture, a sink, a stove, a water reservoir, saddlebag storage units, a mesh carrier, and combinations thereof.

8. The covered mattress assembly of claim 7, wherein the accessory is attached to a tailgate.

9. A covered mattress assembly for a vehicle bed, comprising:
a mattress attached to a cover assembly; wherein the mattress in a storage position is concealed within a vehicle bed by the cover assembly; and wherein in a use position, the mattress position is inverted from the storage position.

10. The covered mattress assembly of claim 9, wherein the mattress further comprises jointed components operative to extend a length of the mattress when in the use position.

11. The covered mattress assembly of claim 9, further comprising a telescoping shell.

12. A covered mattress assembly for a vehicle bed, comprising:
at least one folding mattress and a cover assembly,
wherein the at least one folding mattress is operative to fold into a storage position storable within the vehicle bed under the cover assembly and to unfold into a use position within the vehicle bed.

13. The covered mattress assembly of claim 12, further comprising a mattress attached to a tailgate.

14. The covered mattress assembly of claim 12, wherein the at least one folding mattress is operative to unfold to extend a length of the mattress.

15. The covered mattress assembly of claim 12, further comprising one or more components selected from the group consisting of: support legs, a handle, and central reinforcements.

16. The covered mattress assembly of claim 12, wherein the at least one folding mattress is stored within a tailgate-mounted cover in its storage position.
